(19) United States
(12) Patent Application Publication
(10) Pub. No.: US 2019/0090688 A1
(43) Pub. Date: Mar. 28, 2019

(54) COOKING DEVICES

(71) Applicant: Austin Wilson, Waxahachie, TX (US)

(72) Inventor: Austin Wilson, Waxahachie, TX (US)

(21) Appl. No.: 16/141,802

(22) Filed: Sep. 25, 2018

Related U.S. Application Data
(60) Provisional application No. 62/562,811, filed on Sep. 25, 2017.

(51) Int. Cl. A47J 36/02; A47J 37/07

(52) U.S. Cl. CPC A47J 36/02; A47J 37/0754

(57) ABSTRACT

Presented herein is a cooking device. In one example, the cooking device can include a sealed double walled housing shaped to enclose an internal cooking space and an opening accessible to the internal cooking space. The sealed double walled housing can have an outer wall and an inner wall forming a sealed intervening space therebetween.

### CROSS REFERENCE TO RELATED APPLICATIONS

This application claims the benefit of U.S. Provisional Application No. 62/562,811 filed on Sep. 25, 2018, which is incorporated herein by reference.

### BACKGROUND

Outdoor living and entertaining spaces are growing in demand. These spaces can include outdoor cooking devices. Outdoor cooking is a growing multi-billion dollar per year industry. Urbanization, disposable income, outdoor entertaining, and social gatherings are just a few of the reasons this industry is flourishing. As growth in outdoor cooking continues, there is increased demand for options and improvements in outdoor cooking devices.

### BRIEF DESCRIPTION OF THE DRAWINGS

Additional features and advantages of the disclosure will be apparent from the detailed description which follows, taken in conjunction with the accompanying drawings, together illustrating, by way of example, features of the present technology. It should be understood that the figures are representative examples of the present disclosure and should not be considered as limiting in scope of the disclosure.

FIG. 1 schematically illustrates a cross-section of a cooking device including a double walled housing, in accordance with an example presented herein;

FIG. 2 schematically illustrates an extrapolated view of a double walled housing including a spacer of a cooking device, in accordance with an example presented herein; and

FIG. 3 schematically illustrates a cooking device in accordance with an example presented herein.

### DETAILED DESCRIPTION

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs.

Furthermore, the described features, structures, or characteristics can be combined in any suitable manner in one or more embodiments. In the following description, numerous specific details are provided, such as examples of housing structures, materials, accessories, etc., to provide a thorough understanding of various embodiments. One skilled in the relevant art will recognize, however, that such detailed embodiments do not limit the overall concepts articulated herein, but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

It is noted that, as used in this specification, the singular forms “a,” “an,” and “the” include plural referents unless the context clearly dictates otherwise.

As used herein, “atmospheric pressure” refers to a pressure resulting from the force per unit area exerted against a surface by the weight of the entire atmospheric column of air above that surface. The atmospheric pressure at sea level is generally 1 atmosphere, or about 1013.25 millibars.

In this application, “comprises,” “comprising,” “containing” and “having” and the like can have the meaning ascribed to them in U.S. patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, measurements, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, and 5 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

An initial overview of embodiments is provided below and specific embodiments are then described in further detail. This initial summary is intended to aid readers in understanding the disclosure more quickly, but is not intended to identify key or essential technological features, nor is it intended to limit the scope of the claimed subject matter.

The present disclosure provides a cooking device that can include a double walled housing. The cooking device can be a standalone device or a built-in device that can be utilized for conduction style cooking, convection style cooking, deep frying, or combinations thereof. In some examples, the cooking device can be a grill, smoker, fryer, rotisserie, pizza oven, and combinations thereof. When the cooking device is a grill and the grill can be a gas grill, charcoal grill, wood burning grill, electric grill, infrared grill, and combinations thereof. In some examples, the grill can be a barrel grill, cart-style grill, kamado grill, or a kettle grill. In one example the cooking device can be an outdoor cooking device.

The cooking device can include a variety of structural configurations, depending on the design of the cooking device, the type of cooking for which the cooking device is to be used, and the like. As such, a configuration as it applies to the cooking device as a whole is not limiting. The cooking device can include a double walled housing (“housing”) shaped to form and enclose an internal cooking space, and can insulate the internal cooking space from an area exterior of the cooking device. In some examples, the cooking device can further include a closure to reduce heat loss.

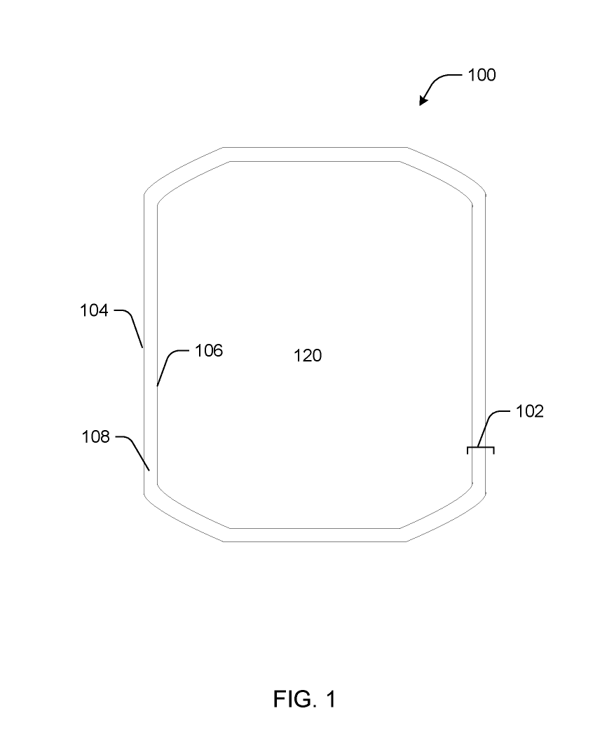

A cross-sectional view of one exemplary cooking device is shown in FIG. 1, which includes a housing 102 having an outer wall 104, an inner wall 106, an intervening space therebetween 108. An internal cooking space 120 is shown surrounded by the housing 102. The shape of the housing 102 thus dictates the shape of the internal cooking space. The exposed surface of the outer wall faces away from the internal cooking space and the exposed surface of the inner wall faces toward the internal cooking space. The double wall structure can contain heat utilized for cooking in the internal cooking space and can reduce heat transfer out of the internal cooking space.

The double walled housing (“housing”) can include an outer wall and an inner wall positioned adjacent to one another to form an intervening space therebetween. In some examples, the outer wall and the inner wall of the housing can be sealed to one another to form a sealed intervening space therebetween. The housing can include shape, structural configuration, and the like, capable of being shaped to form an internal cooking space, and thus is considered to be non-limiting. With this in mind, examples can include various geometric designs and design elements, including without limitation, squares, rectangles, hemispheres, spheres, polygons, ellipses, barrels, ovoids, and the like, including combinations thereof and 2D and 3D representations thereof. In yet other examples, the configuration of the housing can include designs and design elements that are symmetric, asymmetric, or a combination thereof. In some examples, the shape of the housing can be at least partially reflective of, or dictated by, the type or use of the cooking device. For example, a shape of the housing of a grill can differ from a shape of the housing of a fryer.

The materials utilized to construct the outer wall and the inner wall of the housing are not limiting, provided the materials are capable of forming and surrounding an internal cooking space. The outer wall and the inner wall can be made from the same or different materials and can have the same or different structural configurations relating to thickness, surface finish, coatings, and the like. Given the high heat environment of the internal cooking space, at least the inner wall can include a material capable of withstanding such high temperatures. While such materials can generally include metals and metal alloys, in some examples various ceramics, ceramic coatings, high-heat polymers, and the like can be used.

In one example, the outer wall and the inner wall of the housing can include any known and useful metal or metal alloy. Exemplary metals can include aluminum, copper, and iron. Exemplary alloying materials can carbon, chromium, manganese, molybdenum, nickel, silicon, tin, titanium, tungsten, vanadium, zinc, and the like. In another example, the walls of the housing can be an alloy of iron such as cast iron, steel, stainless steels, tool steels, and combinations thereof. In another example, the walls of the housing can include other materials capable of being utilized in heated environments, such as ceramics, porcelain, porcelain enamel, high temperature polymers and polymeric compounds, and the like.

In one example, the outer wall material and the inner wall material can be the same, such as, stainless steel, for example. In another example, the outer wall material and the inner wall material can be different, such as an outer wall of stainless steel and an inner wall of carbon steel. In one example, the inner wall material can be a material that can have a low thermal conductivity. For example, the outer wall can include aluminum and the inner wall can include stainless steel. In another example, the outer wall can include stainless steel and the inner wall can include a ceramic. In further examples, the outer wall, the inner wall, or a combination thereof can include multiple types of materials. For example, the outer wall, the inner wall, or the exposed surface of the outer wall and the inner wall of the housing can include a porcelain coating or an enamel coating on a metal or metal alloy.

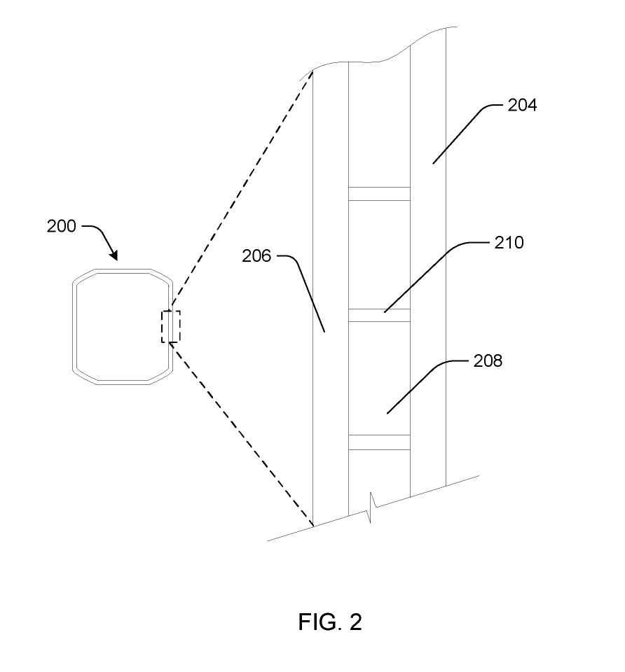

In some examples, the housing can further include spacers extending through the intervening space between the outer wall and the inner wall. The spacer can be positioned to assist in maintaining separation between the outer wall and the inner wall that defines the intervening space. While various designs can be self-supporting with respect to the intervening space, in some examples spacers can be used to provide structural support between the outer wall and the inner wall of the housing to maintain the intervening space during bending or other manipulations. In some cases, the spacers can be used to maintain the intervening space when the housing is formed into a shape that would otherwise collapse the intervening space. An example of a plurality of spacers 210 of a double walled housing having an outer wall 204, an inner wall 206, and an intervening space 208 there between is shown in FIG. 2, where 200 is the cooking device. In FIG. 2, horizontal spacers extend in the space between the outer wall and the inner wall.

In some examples, the spacer can be a rod, although the shape is not particularly limiting. For example, the rod can be flat, round, square, rectangular, or any other polygonal shape. In addition, the cross-section of the rod can be round, rectangular, rectangular with rounded edges, or the like. In one example, the spacer can extend from the outer wall to the inner wall of the housing.

The material utilized to construct the spacer is not particularly limited. In some examples, the material of the spacer can include materials discussed above with respect to the outer wall and the inner wall of the housing. For example, the spacer can include metals, metal alloys, ceramics, ceramic coatings, high-heat polymers, and the like. Exemplary metals can include aluminum, copper, and iron. Exemplary alloying materials can include carbon, chromium, manganese, molybdenum, nickel, silicon, tin, titanium, tungsten, vanadium, zinc, and the like. In another example, the housing can include other materials capable of being utilized in heated environments, such as ceramics, porcelain, porcelain enamel, high temperature polymers and polymeric compounds, and the like. In further examples, the spacer can include materials other than those used for the walls of the housing. For example, the spacer can include carbon, carbon nanotubes, or a heat resistant polymer. The walls of the housing and the spacer can be constructed by any number of techniques that are well known to those skilled in the art.

An average spacing between the outer wall and the inner wall prior to pressing can vary. As used herein, an “average spacing” refers to a number average, based on a cross-sectional dimension at the shortest depth between outer wall and the inner wall of the housing prior to pressing. For example, an average distance of 8 mm can include the cross-sectional dimensions of 4 mm, 2 mm, 6 mm, 10 mm, 12 mm, 10 mm, 8 mm, and 12 mm, which numerically averages 8 mm. In one example, the average spacing between the outer wall and the inner wall and can vary from about 1 mm to about 10 mm. In other examples, the average spacing between the outer wall and the inner wall can vary from about 2 mm to about 7 mm, from about 3 mm to about 6 mm, or from about 4 mm to about 8 mm. In a further example, the average spacing between the outer wall and the inner wall can be equal to or less than 8 mm.

An intervening space can be located between the outer wall and the inner wall of the housing. In some examples, the intervening space can be unsealed; while in others, the intervening space can be sealed from external environments, and thus be a “sealed intervening space.” The intervening space can be configured to enhance the thermal insulation of the double walled housing. In some examples, a sealed intervening space can be capable of maintaining an internal gas pressure independent of atmospheric gas pressure and can provide greater insulation than the insulation provided by a double walled housing of the same material separated by the same average distance which does not have an intervening space having a gas pressure that differs from atmospheric pressure.

In one example, the gas pressure can be less than atmospheric pressure, i.e. the sealed intervening space can be vacuum sealed. As the pressure or concentration of gas molecules in the sealed intervening space decreases, thermal transfer across the intervening space can also decrease. The decreased heat transfer can thereby affect heat transfer to the outer wall and a temperature of the exposed surface of the outer wall. In one example, the exposed surface of the outer wall of the housing does not experience the same increase in temperature as the inner wall of the housing when a temperature of an internal cooking space is elevated. Accordingly, a reduction from atmospheric gas pressure can provide an enhanced insulating effect when compared to a sealed intervening space with atmospheric pressure.

In yet another example, the sealed intervening space can have a gas pressure that can be greater than atmospheric pressure. Depending on a type of gas within the sealed intervening space, this can also have an insulating effect. For example, different gas molecules can have different thermal conductivities. In one example, the sealed intervening space can be filled with a thermal insulating gas. Exemplary thermal insulating gasses can include argon, carbon dioxide, krypton, nitrogen, sulfur hexafluoride, combinations thereof, and the like. These gases can provide greater insulation when compared to atmospheric gas due to their lower thermal conductivity and thus can be used as thermal insulation even at greater gas pressures. In some embodiments, such insulating gasses can be pressurized in the intervening space to further reduce heat transfer.

In some examples, the intervening space can exclude or can substantially exclude particulate and/or solid insulating materials. In other examples, the sealed intervening space can include particulate and/or solid insulating materials in combination with a gas pressure in the sealed intervening space that can differ from atmospheric gas pressure. For example, a particulate and/or solid insulating material can be located between and can line an interior facing surface of the outer wall and/or the inner wall of the housing. In a further example, the sealed intervening space can exclude a particulate and/or solid insulating material and can include a gas pressure that can differ from atmospheric pressure.

The internal cooking space can be any number of shapes and/or designs, and can be formed and defined, at least in part, by the structural configuration of the inner wall of the housing. In some examples, the internal cooking space can provide an area for a heat source and a cooking structure. The heat source and the cooking structure can vary depending on the type of cooking device.

For example, a type of the heat source can be a solid fuels, such as charcoal, wood, fuel pellet, and the like; hydrocarbon fuels, such as propane, natural gas, radiant gas, and the like; electricity; and such. In some examples, the type of the heat source can be a combination of sources. In one example, the type of the heat source can include a gas component and an electrical component. In another example, the type of the heat source can be a single source but can provide multiple types of heating, i.e. a hydrocarbon fuel source that can provide a cooking flame and can heat an infrared element.

In addition, the cooking structure can vary. For example, the cooking structure can be a support for a cooking surface such as a rack, or removable pan. In one example, the cooking structure can be a support surface on the inward facing surface of the inner wall of the housing. In another example, the cooking structure can be a support for a cooking surface. Exemplary cooking surfaces can include a shelf, grate, griddle, rack, fork, pizza stone, combinations thereof, and the like. In some examples, the cooking surface can be removably positioned within the internal cooking space. In yet another example, the cooking structure can be a support for a removable pan configured to receive cooking oil or other liquid.

The intensity of heat, location of the heat source, and the proximity of the heat source to the food can vary cooking conditions. Therefore, a distance between the heat source and the cooking surface can vary depending on a style of the cooking device, an intended use of the cooking device, an intended cooking type, and an intensity range of the heat source. For example, searing generally can occur at high temperature (temperatures at or above 120° F.) with a close heat source; while, slow cooking generally can include indirect heating for prolonged periods of time. Likewise, the location of the heat source with respect to the cooking surface can also vary and in some examples, the heat source can be located above, below, and/or horizontally adjacent to a cooking surface.

An opening can provide access to the internal cooking space. The size, location, and shape of the opening can vary on the intended use of the cooking device. For example, a pizza oven can generally have an opening facing a side of a cooking device; whereas, a grill can have an opening facing a side or facing an upright section of a cooking device.

The sealed intervening space with differing pressure, in combination with the double walled housing can allow the internal cooking space to have an elevated temperature, e.g. a temperature greater than ambient temperature, while allowing the exposed surface of the outer wall to have a temperature lower than the elevated temperature. In some cases, the exposed surface of the outer wall of the housing can be capable of being physically touched without pain or tissue damage, and in other cases the exposed surface of the outer wall of the housing can be cool to the touch when the internal cooking space can have an elevated temperature (temperatures above 100° F.). As used herein, “cool to the touch” refers to a temperature that would allow a user to comfortably touch the exposed surface of the outer wall. For example, this temperature can be less than 100° F., less than 90° F., or less than 80° F.

In one example, the exposed surface of the outer wall of the housing can be structurally configured to remain cool to the touch when the internal cooking space is at a temperature ranging from 100° F. to 500° F. In another example, the exposed surface of the outer wall of the housing can be structurally configured to remain cool to the touch when the internal cooking space is at a temperature ranging from 120° F. to 500° F. In yet another example, at ambient temperatures the exposed surface of the outer wall of the housing can be structurally configured to remain within 10° F. of ambient temperatures when the internal cooking space is heated to a temperature ranging from 400° F. to 600° F. As used herein, “ambient temperature” can refer to a temperature of an environment exterior to and surrounding the cooking device. In a further example, at ambient temperatures the exposed surface of the outer wall of the double walled housing can be structurally configured to remain within 20° F. of the ambient temperature when the internal cooking space is heated to a temperature ranging from 600° F. to 800° F.

This feature of the cooking device can provide several advantages. For example, the cooking device can be utilized safely by individuals without the worry of potential burns from accidentally touching a hot cooking device. The cooking device can also permit ambient temperatures in the area surrounding the cooking device. This can be advantageous as the cooking device can be placed on or near items that may be damaged by heat. In addition, this feature can provide comfort that would generally not be experienced by an individual utilizing an outdoor cooking device that transfers heat to the surrounding area.

Furthermore, the cooking device can be structurally configured to exhibit decreased heat loss, thereby minimizing the costs associated with utilizing the cooking device as less fuel is consumed during cooking. Moreover, the cooking device can provide a consistent cooking environment as a steady internal cooking temperature can be maintained without intervention, even after a heat source has been “snuffed out,” thereby allowing for even cooking and reducing fuel consumption.

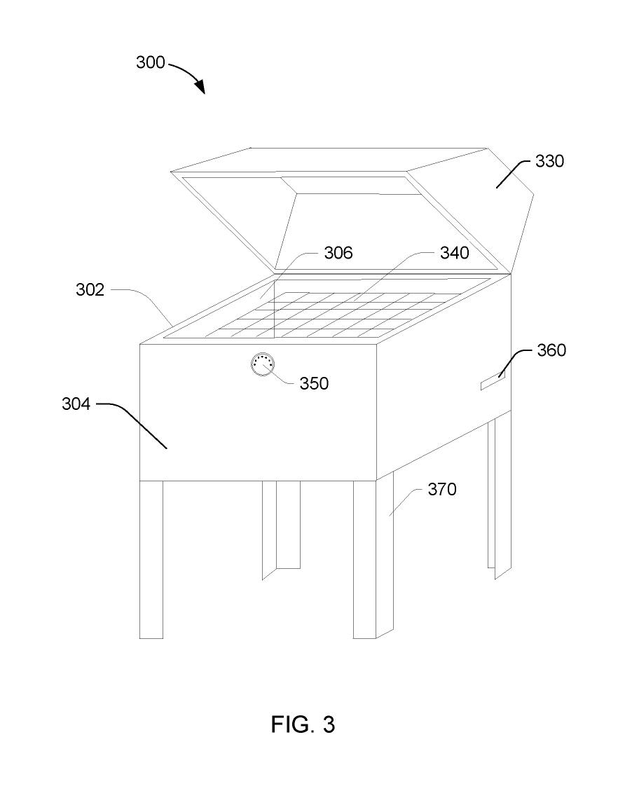

In some examples, the cooking device can further include any of number of additional elements. For example, the cooking device can further include a closure, seal, airflow controller, temperature sensor, regulator, vent, spacer, combinations thereof, and the like. An example illustration of a cooking device 300 including various exemplary features is shown in FIG. 3. In this example, the cooking device 300 can include a double walled housing 302, with an outer wall 306 and an inner wall 304 that are spaced to form an intervening space therebetween. The device can additionally include an internal cooking space, a closure 330, a cooking surface 340, a temperature sensor 350, a vent 360, and a support 370.

In one example, the cooking device can further include a closure to cover or otherwise seal the opening accessible to the internal cooking space. The configuration of the cooking device and the opening can determine the location and/or the type of closure. In some examples, the closure can be a lid, door, sliding cover, or a combination thereof. When the closure is a lid, the lid can be affixed to the double walled housing, or the lid can be a separate pull-away lid. An affixed lid can be attached via a hinge, a pivot point, or other rotatable or movable design. In some examples, the lid can be spring assisted. In one example, a lid can be operable to rotate at a pivot point and can be designed with two sections, one section in a fixed position and a second section that can rotate behind or in front of the fixed section of the lid.

The closure can further minimize heat loss and can prevent debris from entering the internal cooking space. The material utilized to create the closure can vary. In some examples, the closure can include the same or similar materials as the housing. In other examples, the closure can include a different material than the material of the housing. The description of potential materials that can be included in the housing also applies to the closure. In some examples, the closure can have a double walled construction with an outer wall and an inner wall and an intervening space therebetween. In some examples, the outer wall and the inner wall of the closure can be sealed to one another and/or the closure can include spacers. The double walled construction, intervening space, and/or spacers can be as described above with respect to the housing.

In some examples, the cooking device can further include a seal. The seal can provide a thermal seal to prevent, reduce, and/or minimize heat loss that may occur at an opening. In one example, the seal can be located at the interface between the double walled housing and the closure. In other examples, the seal can be located at an interface between the double walled housing and components, such as an entry point for a heat source, an airflow controller, a temperature sensor, and the like. The seal can be located along the entire interface or a portion thereof. In one example, the seal can include a heat resistant material. Exemplary heat resistant seal materials can include a heat resistant rubberized gasket, a woven metal mesh gasket, a fiberglass gasket, a polytetrafluoroethylene gasket, and combinations thereof.

In a further example, the cooking device can include an airflow controller. Exemplary airflow controllers can include passive devices such as dampers, vents, valves, and the like, or active devices such as blowers, fans, and the like. In one example, the cooking device can include a vent. In some examples, the vent can be as simple as an opening, while in another example, the vent can include an opening along with a cover that can be closed. Another exemplary airflow controller can include a damper. In some examples, the cooking device can include multiple airflow controllers that can allow for cross ventilation of the internal cooking space. In other examples, the airflow controller can be adjustable and can allow a user to control the amount of air entering and exiting the internal cooking space. In one example the cooking device can include a fan and vents to circulate hot air around the internal cooking space and allow for convection cooking.

In yet another example, the cooking device can further include a temperature sensor to provide temperature measurements of the internal cooking space. In some examples, an output of the temperature sensor can be communicatively coupled to a regulator of the fuel source to facilitate closed-loop feedback to automatically control the temperature within the internal cooking space.

In yet another example, a cooking device can include a regulator that can modify the environment of the internal cooking space. The regulator can be located external or internal to the cooking device. Non-limiting examples can include a thermal regulation device, humidity regulation device, and the like. For example, a regulator can include a heat diffuser, a vaporizer, a water pan, and the like.

In further examples, the cooking device can include a support. Exemplary supports can include stands, legs, cabinets, and the like. In some examples, the support can be detachable and/or compactable, thus providing a cooking device that can be portable. In yet other examples, the cooking device can be irremovable from the support. In some examples the cooking device can include wheels. In further examples, the support can be designed to attach to a vehicle or watercraft. For example the base can include a hitch attachment, a stow-away support that attaches directly to the vehicle or watercraft, and the like.

### Exemplary Embodiments

In one embodiment, a cooking device is presented. The cooking device can include a sealed double walled housing shaped to enclose an internal cooking space and an opening accessible to the internal cooking space. The sealed double walled housing can include an outer wall and an inner wall forming an intervening space therebetween.

In one embodiment, a gas pressure in the intervening space can differ from atmospheric pressure.

In another embodiment, the gas pressure in the intervening space can be greater than atmospheric pressure.

In yet another embodiment, the intervening space can be vacuum sealed.

In one embodiment, an average spacing between the outer wall and the inner wall, prior to pressing, can range from about 1 mm to about 10 mm.

In another embodiment, the sealed double walled housing can further include a plurality of spacer between the outer wall and the inner wall of the sealed double walled housing arranged to maintain the intervening space.

In yet another embodiment, the cooking device can further include a closure configured to provide access to and cover the opening.

In one embodiment, the closure can be a double walled closure comprising an outer wall and an inner wall forming an intervening space therebetween. An amount of a gas pressure in the intervening space of the double walled closure can differ from atmospheric pressure.

In one embodiment, the closure can include a member selected from the group consisting of a door, a lid, a sliding cover, and a combination thereof.

In another embodiment, a thermal seal can be located at an interface of the double walled closure and the sealed double walled housing.

In yet another example, the thermal seal can include a member selected from the group consisting of a rubber gasket seal, a metal mesh gasket seal, a fiber gasket seal, a polytetrafluoroethylene based gasket seal, and combinations thereof.

In a further embodiment, the cooking device can further include a cooking structure removably positioned within the internal cooking space.

In one embodiment, the cooking device can further include an airflow controller configured to provide access to the internal cooking space to adjust airflow into and out of the internal cooking space.

In another embodiment, the cooking device can further include a fan or a blower and an airflow controller.

In yet another embodiment, an exposed surface of the outer wall of the sealed double walled housing can be structurally configured to remain within 10° F. of ambient temperatures when the internal cooking space is heated to a temperature ranging from 400° F. to 600° F.

In yet another embodiment, the cooking device can include a fan and an exhaust to circulate hot air through the internal cooking space and allow for convection style cooking.

Thus have been described cooking devices. The described features, steps, or characteristics may be combined in any suitable manner in one or more embodiments. It will be apparent to those of ordinary skill in the art that numerous modifications in form, usage and details of implementation can be made without the exercise of inventive faculty, and without departing from the principles and concepts of the invention presented herein.

### EXAMPLE

The following example illustrates the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Insulation Test of a Double Walled Stainless Steel Container

A piece of flaming charcoal was placed within the internal space of an 18/8 stainless steel, vacuum sealed, double walled container having an outer wall and an inner wall with an intervening space therebetween and a lid comprising the same material. The lid was removed, and a temperature of the container was measured internally and externally utilizing a hand held infrared thermometer. The temperature of an exposed surface of the outer wall of the container was 75° F. The temperature within the internal space of the container was 435° F. Accordingly, a vacuum sealed, double walled, stainless steel container exhibits thermal insulating properties for use as a cooking device.

What is claimed is:

1. A cooking device, comprising:
a sealed double walled housing shaped to enclose an internal cooking space; and
an opening accessible to the internal cooking space;
wherein the sealed double walled housing comprises an outer wall and an inner wall forming an intervening space therebetween.

2. The cooking device of claim 1, wherein a gas pressure in the intervening space differs from atmospheric pressure.

3. The device of claim 2, wherein the gas pressure of the intervening space is greater than atmospheric pressure.

4. The device of claim 2, wherein the intervening space is vacuum sealed.

5. The device of claim 1, wherein an average spacing between the outer wall and the inner wall of the sealed double walled housing ranges from about 1 mm to about 10 mm.

6. The device of claim 1, wherein the sealed double walled housing further includes a plurality of spacer between the outer wall and the inner wall of the sealed double walled housing arranged to maintain the intervening space.

7. The device of claim 1, wherein the cooking device further includes a closure configured to provide access to and cover the opening.

8. The device of claim 7, wherein the closure is a double walled closure comprising an outer wall and an inner wall forming an intervening space therebetween and wherein a gas pressure in the intervening space differs from atmospheric pressure.

9. The device of claim 7, wherein the closure comprises a member selected from the group consisting of a door, a lid, a sliding cover, and combinations thereof.

10. The device of claim 7, further comprising a thermal seal located at an interface of the double walled closure and the sealed double walled housing operable to maintain a temperature of the internal cooking space.

11. The device of claim 10, wherein the thermal seal comprises a member selected from the group consisting of a rubber gasket seal, a metal mesh gasket seal, a fiber gasket seal, a polytetrafluoroethylene based gasket seal, and combinations thereof.

12. The device of claim 1, further comprising a cooking surface removably positioned within the internal cooking space.

13. The device of claim 1, further comprising an airflow controller configured to provide access to the internal cooking space to adjust airflow into and out of the internal cooking space.

14. The device of claim 13, further including a fan or a blower.

15. The device of claim 1, wherein an exposed surface of the outer wall of the sealed double walled housing is structurally configured to remain within 10° F. of ambient temperatures when the internal cooking space is heated to a temperature ranging from 400° F. to 600° F.

16. The device of claim 1, wherein the cooking device further includes a fan and an exhaust to circulate hot air through the internal cooking space and allow convection style cooking.
